(19) United States
(12) Patent Application Publication
(10) Pub. No.: US 2002/0163688 A1
(43) Pub. Date: Nov. 7, 2002

(54) Optical communications system and vertical cavity surface emitting laser therefor

(76) Inventors: Zuhua Zhu, San Jose, CA (US); Shih-Yuan Wang, Palo Alto, CA (US)

Correspondence Address: Ivan S. Kavrukov, Cooper & Dunham LLP, 1185 Avenue of the Americas, New York, NY, 10036, US

(21) Appl. No.: 09/927,802

(22) Filed: Aug. 10, 2001

Related U.S. Application Data
(60) Provisional application No. 60/278,724, filed on Mar. 26, 2001.

(51) Int. Cl. H04J 14/02; H04B 10/12

(52) U.S. Cl. 359/124; 359/173

(57) ABSTRACT

A data communications link for use in local area network (LAN) and shorter metropolitan area network (MAN) applications is described, comprising a single-transverse-mode, multiple-longitudinal-mode, long-wavelength optical source and a single-mode optical fiber. Advantageously, single-transverse-mode power can be enhanced when two or more longitudinal modes are present. Moreover, the optical source becomes more thermally robust, because lateral shifts in its active region gain curve will have less effect on the overall transmitted power when two or more longitudinal modes are present. Moreover, very high data transmission rates can be achieved because modal dispersion, attenuation, and chromatic dispersion are not limiting factors. A long-cavity vertical cavity surface emitting laser (VCSEL) structure capable of single-transverse-mode, multiple-longitudinal-mode, long-wavelength operation is described. The described VCSEL is amenable to a single-growth fabrication process. Enhanced VCSEL operation using curved distributed Bragg reflector (DBR) mirrors is also described.

### CROSS-REFERENCE TO RELATED APPLICATIONS

This application claims the benefit of Provisional Application Ser. No. 60/278,724, filed Mar. 26, 2001, which is incorporated by reference herein.

### FIELD

This patent specification relates to optical communications systems and devices. More particularly, it relates to a vertical cavity surface emitting laser (VCSEL), as well as to an optical communications system capable of incorporating such device.

### BACKGROUND

As the world's need for communication capacity continues to increase, the use of optical signals to transfer large amounts of information has become increasingly favored over other schemes such as those using twisted copper wires, coaxial cables, or microwave links. Optical communication systems use optical signals to carry information at high speeds over an optical path such as an optical fiber. Optical fiber communication systems are generally immune to electromagnetic interference effects, unlike the other schemes listed above. Furthermore, the silica glass fibers used in fiber optic communication systems are lightweight, comparatively low cost, and are capable of very high-bandwidth operation.

Fiber optic communication links can be divided into different classes characterized primarily by the distance between the source and the receiver, each class generally using different optical sources and fiber to address unique requirements and cost issues. A first class includes long-distance or long-haul telecommunications links of greater than about 20 km, where chromatic dispersion and loss in single-mode fibers becomes significant. A second class includes local-area network links of less than about 1 km, used for carrying data short distances within a building or around a small cluster of buildings. A third class includes intermediate-length links, between about 1 km and 20 km, for metropolitan and campus area connections and long building backbones. The above classes of communications links are often identified as wide-area network (WAN) links, local area network (LAN) links, and metropolitan-area network (MAN) links, respectively.

As discussed in Hahn et. al., “VCSEL-Based Fiber-Optic Data Communications,” from Vertical Cavity Surface Emitting Lasers: Design, Fabrication, Characterization, and Applications, Wilmsen et. al., eds., Cambridge University Press (1999), at Chapter 11, which is incorporated by reference herein, conventional long-haul (WAN) communications links use single-mode fiber together with distributed feedback (DFB) edge-emitting laser sources. A DFB laser is an edge-emitting laser (EEL) with a fine pitch grating integrated along its length, providing a single-transverse-mode optical signal with a high-precision single longitudinal mode. Most commonly, a set of “N” DFB laser sources emits optical signals at “N” adjacent wavelengths (e.g., at 0.4 nm spacings around a center wavelength of 1550 nm), which are separately modulated and optically multiplexed onto a common wavelength-division-multiplexed (WDM) optical signal. The high-precision DFB laser sources are quite expensive, but their costs are usually modest compared to the overall system costs of the long-haul WAN communications link.

In contrast, the lowering of optical source and receiver costs is a major factor in the design and implementation of local-area network (LAN) communications links and shorter MAN links. Historically, conventional optical LAN links and shorter MAN links used multi-mode fiber with light-emitting diode (LED) sources. Due to their power inefficiency and modulation rate limitations (their maximum modulation rate is about 622 Mbps), LEDs have been replaced by newer vertical cavity surface emitting lasers (VCSELs).

A VCSEL is a solid-state semiconductor laser in which light is emitted from the surface of a monolithic structure of semiconductor layers, in a direction normal to the surface. This is in contrast to edge-emitting lasers, in which light is emitted parallel to the wafer surface. The overall structure of a VCSEL is one of two parallel end mirrors on each side of an active region, the active region producing the light responsive to an electric current through it. The active region is a thin semiconductor structure, while the end mirrors are distributed Bragg reflector mirrors (“DBR mirrors”) comprising alternating layers of differently-indexed material such that wavelengths in a range including the desired operating wavelength λ_{c} are reflected. The effective length “L” of the vertical cavity, defined by a distance between the effective centers of the DBR mirrors, is preferably selected to be an integer multiple of the operating wavelength λ_{c} normalized by the refractive indices of the cavity materials. Conventional VCSEL vertical cavity lengths are typically one to three times the operating wavelength λ_{c}. Generally speaking, conventional VCSELs will operate when a wavelength meeting a cavity resonance condition also falls within a gain spectrum of the active region, i.e., within a range of wavelengths for which the active region provides sufficient amplification of light. The DBR mirrors must, of course, also provide sufficient reflectivity at this wavelength.

VCSELs combine certain advantages of edge-emitting lasers and LEDs, making them ideal sources for data communications. Like LEDs, VCSELs are surface-emitting devices amenable to planar fabrication and wafer level testing for lower-cost production. Like edge-emitting lasers they can be modulated at high speeds with low noise and higher efficiency. Additional well-known advantages include circular output beams and low numerical aperture allowing for easier introduction of the emitted light into the fiber.

Conventional LAN communication links and shorter MAN links use multi-transverse-mode VCSEL sources together with multi-mode fiber, these VCSEL sources generally being short-wavelength devices (e.g., 850 nm, 980 nm, etc.). Multi-transverse-mode VCSELs are characterized by multiple transverse modes in their output. Although they have short cavities, multi-transverse-mode VCSELs generally yield optical signals with multiple spectral lines near a center wavelength. This is predominantly due to slightly differing wavelengths among the multiple transverse modes. The LAN or MAN links using these VCSEL sources may be single-channel systems or WDM systems. For WDM implementations, coarse WDM methods are commonly used, wherein inter-channel spacings are on the order of 20 nm or larger. The coarse WDM channel spacings allow for lower-cost WDM optical hardware to be used, and also accommodate spectrum spreading brought about by the multiple spectral lines associated with these VCSEL sources.

One problem in conventional LAN communications links and shorter MAN links that use multi-transverse-mode VCSEL sources is an upper bandwidth limit that is becoming increasingly problematic as desired modulation rates continue to increase. Generally speaking, conventional LAN communications links and shorter MAN links that use multi-transverse-mode VCSEL sources and multi-mode fiber are limited to a bandwidth-distance product of about 1 Gbps-km. Thus, a 5 km link would be limited to a 200 Mbps modulation rate, a 1 km link would be limited to a 1 Gbps modulation rate, a 400 m link would be limited to a 2.5 Gbps modulation rate, and so on. It would be desirable to provide a LAN or shorter MAN communications link capable of a substantially higher bandwidth-distance product, i.e., capable of a substantially higher modulation rate for a given distance, as compared to conventional LAN or shorter MAN links. At the same time, however, it would be desirable to provide a solution that keeps the costs associated with the optical sources and receivers under control.

Long-wavelength, single-transverse-mode VCSELs emitting within the range of 1300-1550 nm have been proposed and studied, most commonly in the context of providing lower-cost optical sources for longer MAN or WAN communications links. Substantial effort has been made in generating high quality single-transverse-mode VCSELs for WDM communications links in longer MAN and WAN environments.

As discussed in U.S. Pat. No. 5,825,796, which is incorporated by reference herein, production of long wavelength VCSELs has been inhibited by several material problems. For example, while the use of InP substrates allows straightforward formation of an active region amplifying in the 1300-1550 nm range, production of efficient DBRs is difficult because of low refractive index differences between InP material system layers. Furthermore, while the use of GaAs substrates allows for straightforward formation of efficient DBRs, it is difficult to grow reliable, laser-quality active region material that is effective in the 1300-1550 nm region.

To deal with the more difficult material systems, some prior art long-wavelength VCSELs have used dielectric DBRs with the InP material system. Because of the more substantial refractive index difference between the dielectric layers, a lesser and more practical DBR thickness is realized. However, because the dielectric material has no lattice structure, it may not be epitaxially grown on the substrate material. Instead, a multiple-growth process followed by a wafer bonding process has generally been used. Multiple-growth VCSEL fabrication methods stand in contrast to single-growth fabrication methods. Multiple-growth VCSEL fabrication methods are generally required when, due to nonconformance of DBR material with the active region material system, or due to the presence of complex structures, two or more wafers must be separately fabricated and then fused or bonded together. In addition to the cost and complexity of the multiple wafer growth and bonding process, the results are often less satisfactory than the results of single-growth processes due to the possibilities of mismatches, boundary oxidation, active layer thermal/stress damage, or other singularities along the component wafer boundaries that may lead to reduced device performance and/or reduced device reliability.

As known in the art, single-transverse-mode operation of VCSELs can be achieved by narrowing the output aperture, which inhibits higher-order modes (i.e., non-T00 modes) from escaping the device. The output aperture can be narrowed by adding an opaque layer near the surface of the device having a small opening (e.g., 5 μm) at the center of the device. The current confinement mechanism of a VCSEL near its active region (e.g., lateral oxidation) can also be used to narrow the output aperture. The higher-order transverse modes are inhibited from escaping because they tend to resonate along paths that are at an angle compared to the fundamental mode. Attenuating optical material may also be introduced in the vertical cavity away from the center line to inhibit the higher order transverse modes. Generally speaking, one problem with the above approaches is a reduction in the output power of the fundamental mode itself due to reduced active volume in the active region. As an alternative or a supplement to narrowing the output aperture, the use of a longer vertical cavity can result in increased-area single mode operation and/or increased single-mode power.

In Unhold et. al., “Improving Single-Mode VCSEL Performance by Introducing a Long Monolithic Cavity,” IEEE Photonics Technology Letters, Vol. 12, No. 8 (August 2000), which is incorporated by reference herein, intra-cavity spacers are used to increase the conventional vertical cavity length by 2, 4, and 8 μm for a VCSEL having an operating wavelength λ of 975 nm. As stated therein, one benefit of a longer cavity length is a reduced far field angle of the output beam, i.e., a reduced amount of beam spreading. Additionally, since a larger aperture can be used, increased single-mode output power and increased-area single-mode operation may be achieved using the longer cavity lengths.

As discussed in the Unhold reference supra, longer cavity lengths can bring about the introduction of additional longitudinal modes in the output. Unhold teaches the avoidance of these additional longitudinal modes through manipulation of the active region gain curve with respect to the cavity resonance criteria, such that large-area single-transverse-mode operation and single-longitudinal-mode operation result. One practical disadvantage, however, is that the device will be very thermally sensitive, with the single emitted longitudinal mode hopping from one longitudinally resonant wavelength to another as temperature and/or current is varied (see Unhold, supra, at FIG. 4).

Among the many issues that the prior art has wrestled with in the fabrication of long-wavelength and single-transverse-mode VCSELs is maintaining their operation in single longitudinal mode. The desire for single-longitudinal-mode operation is largely “presumed” because it is consistent with maintaining a narrow spectrum for each optical channel in a WDM system. In turn, keeping each channel's spectrum narrow is consistent with packing a greater number of channels onto a single fiber, providing greater overall spectral efficiency on the targeted WAN and MAN links. Indeed, in many publications, the term “single mode” is commonly used to denote the combination of single-transverse-mode and single-longitudinal-mode operation.

It would be desirable to provide a low-cost data communications link for LAN and shorter MAN applications having a higher data rate than that provided by conventional 1 Gbps-km systems.

It would be further desirable to provide a VCSEL source for such data communications link that is amenable to a low-cost, single-growth fabrication process.

It would be further desirable to provide a VCSEL source for such data communications link that exhibits high thermal stability.

It would be still further desirable to provide a method for decreasing the far-field angle of such VCSEL source or other VCSEL sources.

It would be even further desirable to provide a method for increasing the fundamental mode output power for such VCSEL source or other VCSEL sources.

It would be even further desirable to provide a method for enhanced removal of higher-order transverse modes from a VCSEL output.

### SUMMARY

A data communications link for use in local area network (LAN) and shorter metropolitan area network (MAN) applications is provided, comprising a single-transverse-mode, multiple-longitudinal-mode, long-wavelength optical source, a single-mode optical fiber for transporting the optical signal, and an optical receiver for receiving the optical signal. In one preferred embodiment, the optical signal lies within a range of wavelengths corresponding to the single-mode propagation capability of the single-mode fiber, which is commonly between 1200-1600 nm. Advantageously, because modal dispersion is not a factor with single-transverse-mode signals, the optical signal may be modulated at a very high data rate, e.g., 10 Gbps or higher. Moreover, because attenuation and chromatic dispersion characteristics of single-mode optical fiber are not problematic for the very short distances associated with LAN or short MAN links (e.g., less than about 10 km), the practical maximum data rate is limited only by the maximum modulation rate of the optical source.

According to a preferred embodiment, the optical source is a stimulated-emission device having a cavity and an active region that amplifies light within a gain spectrum. The optical signal emitted by the optical source comprises at least two longitudinal modes lying within the gain spectrum. The two longitudinal modes are separated by an interval that is inversely proportional to the length of the cavity. Thus, according to one preferred embodiment, the optical source is designed such that a resonant condition in the cavity is satisfied by at least two distinct wavelengths lying within the gain spectrum.

Advantageously, single-transverse-mode power can be enhanced when two or more longitudinal modes are present. Moreover, the optical source becomes more thermally robust, because lateral shifts in the gain curve will have less effect on the overall transmitted power when two or more longitudinal modes are present. Also, lower-cost optical receivers that are “de-tuned” to detect power across a wider spectral range may be used at the receiving end of the communications link, thereby lowering overall system costs.

According to a preferred embodiment, a coarse wavelength division multiplexing (WDM) scheme is used to combine two or more single-transverse-mode, multiple-longitudinal-mode optical signals from separate optical sources onto a common single-mode optical fiber. The optical sources differ in operating wavelength by an amount sufficient to ensure that longitudinal modes emitted from a first optical source do not overlap with the longitudinal modes emitted from a second optical source, any such leakage being kept to a very small value (e.g., −30 dB or less).

According to a preferred embodiment, one or more of the optical sources comprises a single-transverse-mode, multiple-longitudinal-mode, long-wavelength vertical cavity surface emitting laser (VCSEL), comprising an active region lying within a vertical cavity defined by top and bottom distributed Bragg reflector mirrors (DBR mirrors). The top and bottom DBR mirrors are designed to reflect light across a large portion of the gain spectrum of the active region, such that at least two longitudinal modes are supported. The vertical cavity has a length defined by a distance between effective centers of the DBRs. Advantageously, multiple longitudinal modes are effectuated by the use of a longer vertical cavity, which in turn allows for increased single-transverse-mode output power because of an increased active volume in the active region. In accordance with one preferred embodiment, the vertical cavity length is more than three (3) times the nominal center wavelength of the VCSEL. Longer cavity lengths, e.g., ten (10) or even fifty (50) times the nominal center wavelength of the VCSEL, can be employed to further enhance single-transverse-mode operation and to increase the number of possible longitudinal modes.

A long-wavelength VCSEL that is based on an InP or similar material system is also provided, comprising dielectric DBR mirrors for high cavity reflectivity, and further comprising a lateral overgrowth layer above a bottom DBR mirror to serve as a vertical cavity spacer layer between the bottom DBR mirror and the remainder of the vertical cavity layers. The DBR mirrors may alternatively comprise different amorphous materials, such as certain conducting or partially conducting amorphous materials that provide sufficient DBR efficiency (e.g., TiO₂/SiO₂, SiC/Si). In accordance with a preferred embodiment, the lateral overgrowth layer advantageously serves the dual purposes of (1) providing a high-quality, low-loss material structure to achieve the desired spacing between the DBR mirrors, and (2) accommodating the presence of the amorphous DBR mirrors, which have no lattice structure and therefore could not be epitaxially grown on the InP substrate. Because the length of the vertical cavity is multiple times the operating wavelength of the device or greater, there is sufficient room for the lateral overgrowth layer to achieve sufficient flatness prior to growth of subsequent material layers such as active layers or multiple quantum wells. Optionally, the bottom DBR mirror is deposited in a shallow well formed in the InP substrate prior to the lateral overgrowth process, such that the top surface of the DBR mirror is level with, or slightly below, the surface of the InP substrate. This allows the InP overgrowth to achieve sufficient flatness if a vertical cavity of lesser length is required.

According to a preferred embodiment, the long-wavelength VCSEL structure can be made multi-longitudinal mode through proper selection of the active region materials with respect to the cavity length. Additionally, single-transverse-mode operation is achieved by narrowing the output aperture with respect to the cavity length as known in the art. Advantageously, however, single-transverse-mode power is enhanced by the combination of the longer cavity length and the multiple longitudinal modes in accordance with the preferred embodiments.

According to another preferred embodiment, in the context of the single-transverse-mode, multiple-longitudinal-mode, long-wavelength VCSEL supra or in other VCSEL contexts, an enhanced VCSEL structure and fabrication method are provided, the VCSEL comprising dual distributed Bragg reflectors (DBRs) defining a vertical cavity that includes an active region, wherein at least one DBR is curved in shape. In one preferred embodiment, a first DBR remains planar while a second DBR is curved, with the curved DBR being concave with respect to the vertical cavity. Advantageously, when the curvature of the curved DBR is such that the vertical cavity represents a stable resonator, diffraction losses and/or geometrical losses are reduced, and therefore the lasing threshold current is reduced. This is particularly useful for incorporation into longer-cavity VCSELs that may otherwise have an increased lasing threshold current due to their longer vertical cavity length and increased active volume. Additionally, in the case of a single-transverse-mode VCSEL, single-transverse-mode performance is enhanced and far-field angle is decreased.

In another preferred embodiment, a first DBR remains planar while a second DBR is curved, with the curved DBR being convex with respect to the vertical cavity. It has been found that the use of a convex DBR may be used for producing an output comprising a single-transverse-mode at substantially higher bias currents, which may be desirable for some applications, e.g., very high-speed applications.

### BRIEF DESCRIPTION OF THE DRAWINGS

FIG. 1 illustrates a single-channel optical communications link in accordance with a preferred embodiment;

FIG. 1A illustrates power spectra of a transmitted optical signal corresponding to the data communications link of FIG. 1;

FIG. 2 illustrates a wavelength-division-multiplexed (WDM) data communications link in accordance with a preferred embodiment;

FIG. 2A illustrates a power spectrum of a transmitted optical signal corresponding to the WDM data communications link of FIG. 2;

FIG. 3 illustrates a long-cavity vertical cavity surface emitting laser (VCSEL) in accordance with a preferred embodiment;

FIG. 4 illustrates a conceptual diagram of a lateral overgrowth process corresponding to the VCSEL of FIG. 3 in accordance with a preferred embodiment;

FIG. 5 illustrates a VCSEL having a concave distributed Bragg reflector (DBR) mirror in accordance with a preferred embodiment;

FIG. 6 illustrates a perspective cut-away view of a VCSEL having a concave DBR mirror in accordance with a preferred embodiment;

FIG. 7 illustrates a perspective cut-away view of a VCSEL having a concave DBR mirror in accordance with a preferred embodiment;

FIG. 8 illustrates steps for forming a concave DBR mirror in accordance with a preferred embodiment;

FIG. 9 illustrates a VCSEL having a convex DBR mirror in accordance with a preferred embodiment; and

FIG. 10 illustrates steps for forming a convex DBR mirror in accordance with a preferred embodiment.

### DETAILED DESCRIPTION

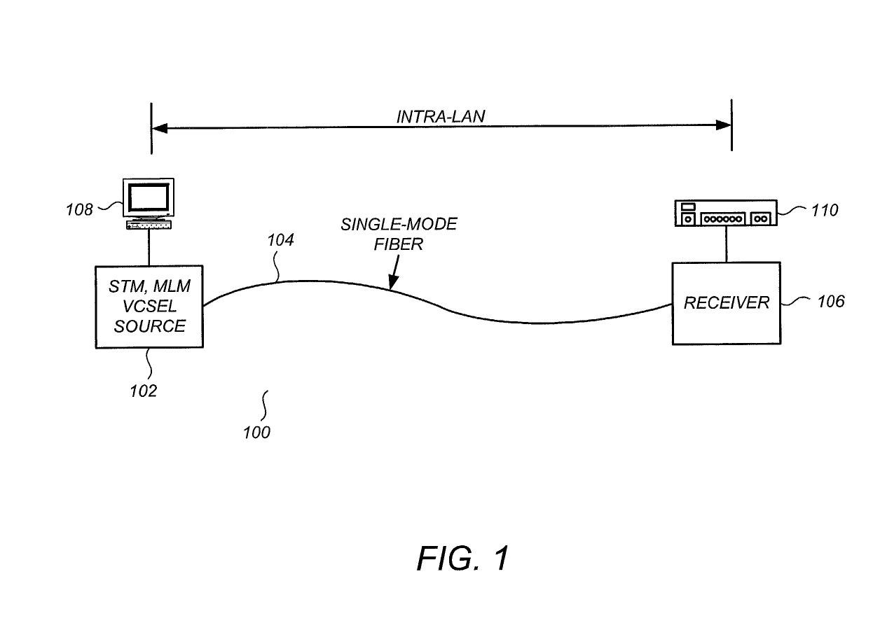

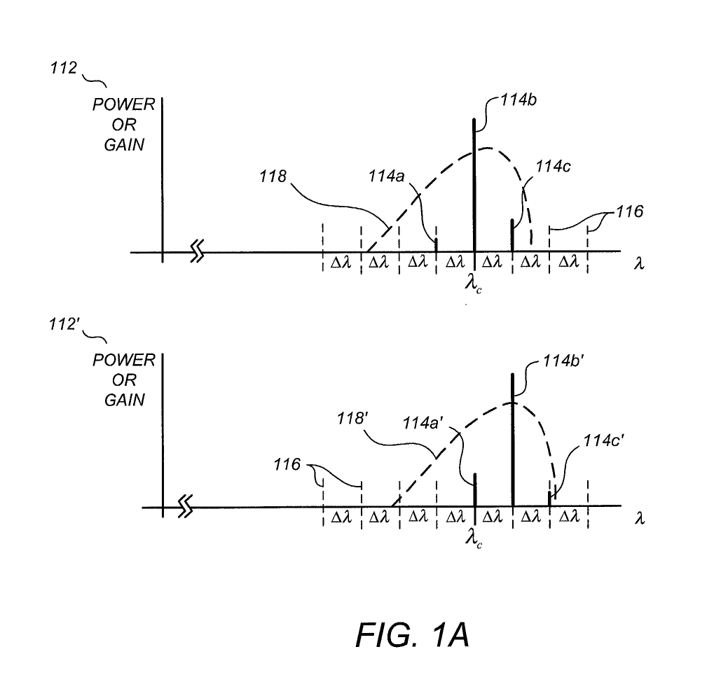

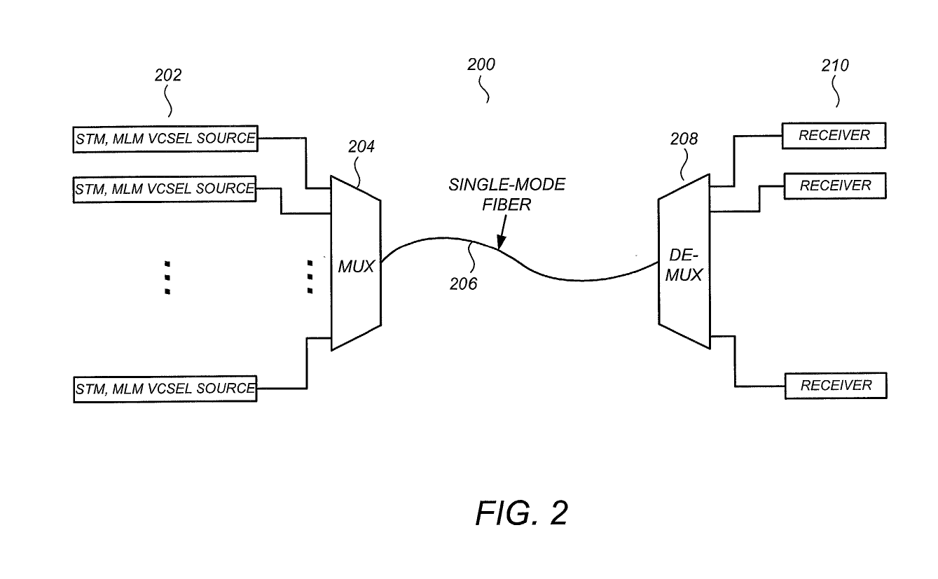

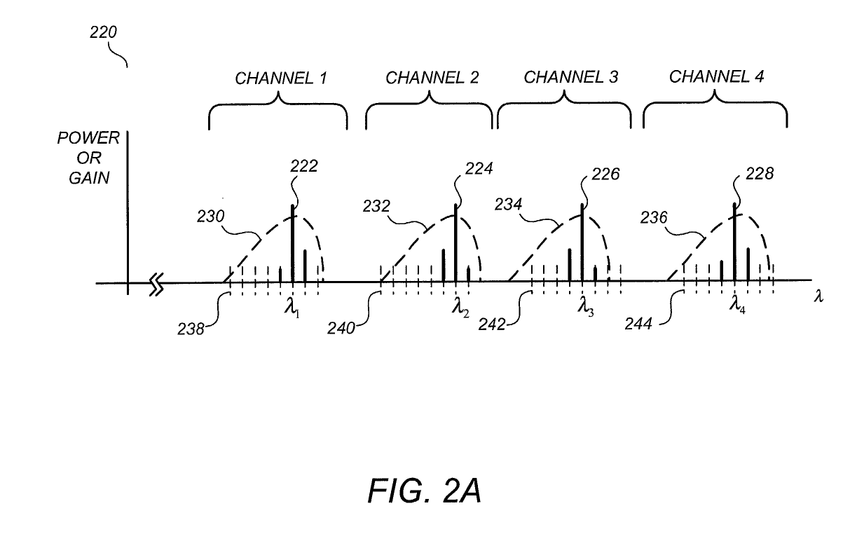

FIG. 1 illustrates an optical communications link 100 in accordance with a preferred embodiment, comprising a single-transverse-mode (STM), multiple-longitudinal-mode (MLM) VCSEL source 102, a single-mode fiber 104, and a receiver 106. The example of FIG. 1 shows the optical communications link 100 in a simplified form, showing only a single source node, such as a workstation 108, and a single destination node, such as a router 110. It is to be appreciated that the optical communications link 100 will generally be part of a larger enterprise network having many more source and destination nodes. The exemplary optical communications link 100 of FIG. 1 is a single-channel link, it being understood that it may be readily configured in a multiple-channel WDM implementation, as will be described infra with respect to FIG. 2. The exemplary optical communications link 100 of FIG. 1 is unidirectional or half-duplex, i.e., data is communicated only from the workstation 108 to the router 110 over the that link. A separate optical communications link (not shown) may be added to transmit data from the router 110 to the workstation 108. It is to be appreciated, however, that a bidirectional or full-duplex link would be within the scope of the preferred embodiments.

The single-mode fiber 104 may generally be any optical fiber that maintains single transverse mode behavior for the wavelengths of interest. As known in the art, optical fibers are inherently multiple-longitudinal-mode devices (provided, of course, that the longitudinal modes of interest are within their passband), and so optical fibers are generally not characterized in terms of longitudinal-mode propagation. Therefore, the simpler term “single mode fiber” shall be used herein instead of “single transverse mode fiber,” it being understood that multiple longitudinal modes are propagated unless otherwise indicated.

By way of example, a conventional off-the-shelf single-mode optical fiber may be used that maintains single-mode propagation between about 1200 nm-1600 nm. The single-mode fiber may have, for example, a core diameter of about 9 μm, a cladding diameter of about 100 μm, and a refractive index difference of about 0.2% between the core and the cladding material. Advantageously, across these and other wavelengths of interest, attenuation and chromatic dispersion characteristics of the optical fiber are not problematic, even in the OH absorption peak interval around 1400 nm, for the short distances involved in LAN and shorter MAN communications links (e.g., <10 km). In one preferred embodiment, the distance between the receiver 106 and the source 102 is sufficiently small such that attenuation and chromatic dispersion caused by the single-mode fiber 104 are nonlimiting factors in designing the optical communications link 100. By way of example and not by way of limitation, if the overall attenuation is kept below 15 dB and the overall chromatic dispersion kept below 200 ps/nm, attenuation and chromatic dispersion caused by the single-mode fiber 104 will be nonlimiting factors for maximum known modulation rates (up to 40 Gbps). In another preferred embodiment, the distance between the receiver 106 and the source 102 is sufficiently small such that attenuation and chromatic dispersion caused by the single-mode fiber 104 are negligible factors in designing the optical communications link 100. By way of example and not by way of limitation, if the overall attenuation is kept below 5 dB and the overall chromatic dispersion kept below 50 ps/nm, attenuation and chromatic dispersion caused by the single-mode fiber 104 will be negligible factors for maximum known modulation rates and would not even need to be checked.

Moreover, because modal dispersion is not a factor with single-transverse-mode signals, the optical signal may be modulated at a very high data rate, e.g., 10 Gbps or higher. While a wavelength range of 1200 nm-1600 nm is described in the above example, a wider range of single-mode operating wavelengths may be used where supported by the optical fiber. By way of example, the optical fibers described in commonly assigned Ser. No. 09/781,352, which is incorporated by reference herein, may be used to expand the single-mode wavelength range of the communications link 100.

The optical communications link 100 may be one of several optical links sharing a fiber optic ribbon cable (not shown) between the source and the destination locations. Overall bandwidth between the source and destination is thereby increased by a factor of “M” where M is the number of optical fibers in the fiber optic ribbon cable. By way of example and not by way of limitation, the FLEX-LITE fiber optic ribbon cable available from W. L. Gore & Associates may be used, which comprises M=12 fiber optic strands in a common ribbon cable. Other types of multifiber cables may optionally be used. In another preferred embodiment, each optical communications link in the fiber optic ribbon cable comprises a “K”-channel WDM optical communications link, as will be described further infra. In this preferred embodiment, overall bandwidth between the source and destination is thereby increased by a factor of “KM,” where K is the number of channels in each WDM link and M is the number of optical fibers in the fiber optic ribbon cable.

Thus, for LAN and shorter MAN communications links using STM sources and single-mode fibers in accordance with the preferred embodiments, the practical maximum data rate is limited primarily by the maximum modulation rate of the optical source. Although a gain-bandwidth product limitation is less meaningful in describing communications links in which modal dispersion is not present, it is readily seen that a gain-bandwidth product of 100 Gbps-km is achieved by a 10 km link operating at 10 Gbps.

FIG. 1A illustrates a plot 112 of spectral lines 114a, 114b, and 114c of an optical signal transmitted over the data communications link 100 of FIG. 1, the optical signal being generated by the STM, MLM VCSEL source 102. Superimposed on the plot 112 is a gain spectrum 118 corresponding to the active region of VCSEL source 102. Spectral line 114b represents the main longitudinal mode at a nominal center wavelength λ_{c}, while spectral lines 114a and 114c represent side longitudinal modes. Also superimposed on the plot 112 are candidate longitudinal mode wavelengths 116 separated by intervals of Δλ. Each of the candidate longitudinal mode wavelengths 116 represents a wavelength for which Eq. (1) below is satisfied for the VCSEL 102, where L_{eff} is the effective vertical cavity length, λ_{c} is the nominal center wavelength, m is an integer, and η_{eff} is the effective index of refraction of the vertical cavity:

$${L}_{eff} = \frac{{λ}_{c} \cdot m}{2 {η}_{eff}} \qquad \{ 1 \}$$

It is readily shown that the distance Δλ between candidate longitudinal mode wavelengths 116 is given by Eq. (2) below:

$$Δ λ = \frac{{( {λ}_{c} )}^{2}}{2 {η}_{eff} {L}_{eff}} \qquad \{ 2 \}$$

According to a preferred embodiment, the VCSEL 102 is designed such that two or more candidate longitudinal mode wavelengths 116 fall within the gain spectrum 118 to create a main longitudinal mode and at least one side longitudinal mode, the side longitudinal mode power being at least −20 dB with respect to the power in the main longitudinal mode. In general, when more than one candidate wavelength 116 falls within the gain spectrum, a dominant longitudinal mode will arise at the candidate wavelength for which the gain spectrum is the greatest, because most of the transmitted energy will “gravitate” toward that wavelength. In the example of plot 112 of FIG. 1A, the dominant mode 114b is selected to be the nominal center wavelength λ_{c} of the VCSEL 112. Some energy, however, will be transmitted at one or both of the wavelengths 114a and 114c immediately adjacent the dominant longitudinal mode wavelength if those wavelengths are within the gain spectrum. In general, the energy present in the side modes 114a and 114c becomes greater as Δλ is decreased. Generally speaking, candidate wavelengths that are separated from the dominant wavelength by 2Δλ or more will contain very small amounts of energy.

As discussed in Kasahara, “Optical Interconnection Applications and Required Characteristics,” from Vertical Cavity Surface Emitting Lasers: Design, Fabrication, Characterization, and Applications, Wilmsen et. al., eds., Cambridge University Press (1999), at Chapter 10, which is incorporated by reference herein, methods can be used to manipulate the position and width of the gain spectrum 118. In general, VCSEL structures with active regions having a gain bandwidth of 50 nm or greater are suitable for use in conjunction with the preferred embodiments. The DBR mirrors should, of course, be sufficiently reflective for all wavelengths of interest including the dominant longitudinal mode wavelength and the side mode wavelengths. The specific VCSEL dimensions and device parameters required to cause two or more candidate longitudinal mode wavelengths to fall within the gain spectrum such that side longitudinal mode power is at least −20 dB with respect to the dominant longitudinal mode power will depend largely on the specifics of the VCSEL materials used, the current confinement scheme, and other factors. Given the present disclosure, these can be readily determined by one skilled in the art using computer simulation, laboratory fabrication, testing, etc.

For purposes of clearly describing the preferred embodiments, and not by way of limitation, a simplified example for VCSEL 102 is presented having a nominal center wavelength of λ_{c}=1500 nm. The gain spectrum of the VCSEL has a peak at about 1510 nm, and its gain bandwidth is 60 nm. The VCSEL is based on an InP material system having an average index of refraction of η_{eff}=3. The VCSEL comprises DBR mirrors that have sufficient reflectivity between 1450 nm-1550 nm. In a first example, the VCSEL is constructed to have an effective cavity length L_{eff} of 15 μm=10λ_{c}. Using Eq. (2), the distance Δλ between candidate longitudinal modes is λ_{c}/60=25 nm. Thus, there will be candidate longitudinal modes at ( . . . , 1450 nm, 1475 nm, 1500 nm, 1525 nm, 1550 nm, . . . ). Thus, in addition to the dominant longitudinal mode at 1500 nm, there will also be a side mode at 1525 nm as this falls within the gain spectrum of the active region. Parameters such as those presented in Kasahara, supra, and other parameters may be adjusted so that the energy at 1525 nm is at least −20 dB with respect to the energy at 1500 nm. In a second example, the VCSEL is constructed to have an effective cavity length L_{eff} of 75 μm=50λ_{c}. Using Eq. (2), the distance Δλ between candidate longitudinal modes is λ_{c}/300=5 nm. Thus, there will be candidate longitudinal modes at ( . . . , 1490 nm, 1495 nm, 1500 nm, 1505 nm, 1510 nm, 1515 nm, 1525 nm, etc . . . ). In this example, the dominant mode will “gravitate” toward 1510 nm (assuming this is the highest-gain candidate wavelength) and there will be one or two side modes at 1505 nm and/or 1515 nm depending on the specific shape of the gain spectrum.

As known in the art, the gain curve 118 can shift as the temperature/current is varied. This can be the cause of thermal instability in conventional prior art STM, SLM devices, because the power in the single transmitted longitudinal mode depends greatly on where its wavelength sits relative to the gain spectrum curve. However, as indicated by the plot 112′ of FIG. 1A, an STM, MLM VCSEL in accordance with the preferred embodiments can exhibit improved thermal stability. In the example of plot 112′, the VCSEL current has changed by an amount sufficient to cause the gain spectrum to shift to the right by several nanometers. However, in an STM, MLM VCSEL in accordance with the preferred embodiments, a new dominant longitudinal mode 114b′ arises due to the gain spectrum shift, and new side modes 114a′ and/or 114c′ also arise accordingly. Whereas the power of any single longitudinal mode will rise or fall significantly according to its position on the shifted gain spectrum curve, the combined power of the multiple longitudinal modes will tend to remain more stable.

Thus, advantageously, single-transverse-mode power can be enhanced when two or more longitudinal modes are present. Moreover, the optical source becomes more thermally robust, because lateral shifts in the gain curve will have less effect on the overall transmitted power when two or more longitudinal modes are present. Also, lower-cost optical receivers that are “de-tuned” to detect power across a wider spectral range may be used at the receiving end of the communications link, thereby lowering overall system costs.

FIG. 2 illustrates an N-channel wavelength-division-multiplexed (WDM) data communications link 200 in accordance with a preferred embodiment, comprising “N” STM, MLM VCSEL sources 202, a WDM multiplexer 204, a single-mode fiber 206, a demultiplexer 208, and “N” receivers 210. The VCSEL sources 202 are each similar to the VCSEL source 102 of FIG. 1. However, the VCSEL sources 202 will generally have gain bandwidths that are in a narrower range (e.g., between 20 nm-40 nm) and candidate longitudinal mode separations Δλ that are also in a narrower range in order to accommodate more WDM channels. Advantageously, however, the wavelength range of operation of the WDM link 200 is substantially wider than the traditional, narrow ranges of operation of single-mode fiber. This is because erbium-doped fiber amplifiers (EDFAs) are not required for the LAN and shorter MAN communications links according to the preferred embodiments, and thus the operating wavelengths are not restricted, for example, to the narrow 1530-1570 nm band associated with long-haul single-mode WDM optical communications links. The multiplexer 204 and demultiplexer 208 are similar to conventional WDM multiplexers, but are advantageously less expensive to produce compared to long-haul single-mode WDM multiplexer/demultiplexers because of their relaxed channel spacings.

FIG. 2A illustrates a spectral plot 220 of a transmitted optical signal corresponding to the WDM data communications link 200 of FIG. 2. The 4-channel configuration of FIG. 2 is given by way of example only, and not by way of limitation, it being understood that the scope of the preferred embodiments extends to a wide range of channels, inter-channel separations, and intra-channel longitudinal mode separations. In the 4-channel example of FIG. 2A, the transmitted optical signal comprises a first channel 222 centered at a nominal wavelength λ₁, a second channel 224 centered at a nominal wavelength λ₂, a third channel 226 centered at a nominal wavelength λ₃, and a fourth channel 228 centered at a nominal wavelength λ₄. Also shown in FIG. 2A are superimposed plots of a gain curve 230 and candidate longitudinal mode wavelengths 238 for the first channel, a gain curve 232 and candidate longitudinal mode wavelengths 240 for the second channel, a gain curve 234 and candidate longitudinal mode wavelengths 242 for the third channel. a gain curve 236 and candidate longitudinal mode wavelengths 244 for the fourth channel. As indicated in FIG. 2A, each channel comprises a center or dominant longitudinal mode at the candidate wavelength having the largest gain spectrum value, and further comprises one or two side longitudinal modes having a power that is at least −20 dB with respect to the dominant longitudinal mode power.

By way of example and not by way of limitation, a set of nominal center wavelengths of FIG. 2A may λ₁=1350 nm, λ₂=1400 nm, λ₃=1450 nm, and λ₄=1500 nm. The gain spectrum of each channel may have a gain bandwidth of about 40 nm with a gain spectrum maximum near the nominal center wavelength for that channel. The effective length of each VCSEL cavity may be L_{eff}=20λ, thereby causing the candidate longitudinal mode separations to be approximately (λ/120), which is sufficiently close to cause two or more candidate longitudinal modes to fall within the gain spectrum for each channel. Parameters such as those presented in Kasahara, supra, and other parameters may be adjusted so that the energy of the side longitudinal mode(s) for each channel is at least −20 dB with respect to the energy of the dominant longitudinal mode.

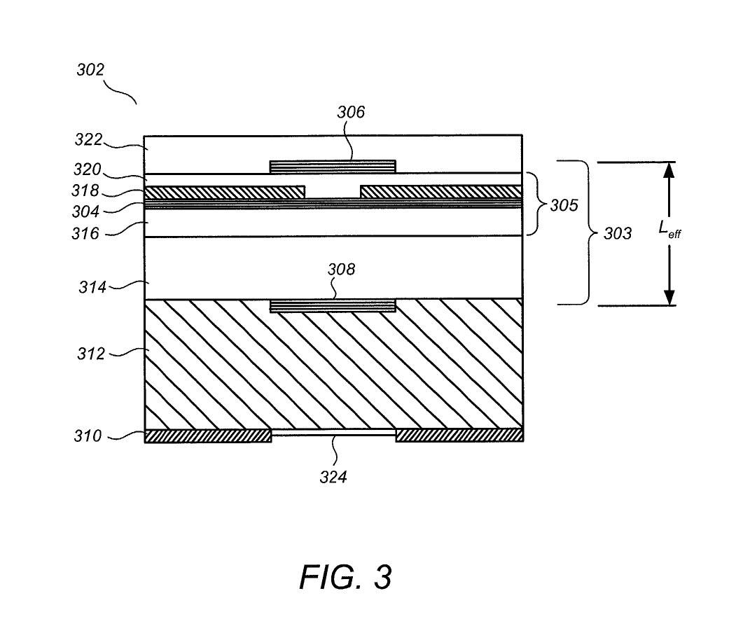

FIG. 3 shows a side cutaway view of an STM, MLM VCSEL 302 capable of being used in conjunction with an optical communications link in accordance with a preferred embodiment, the VCSEL 302 also being capable of fabrication in a single-growth process. For simplicity and clarity of explanation, a VCSEL structure that uses buried proton or oxygen implantation as a current confinement method is described. It is to be appreciated, however, that any of a variety of current confinement structures (e.g., etched mesa, dielectric apertured, buried heterostructure, etc.) may be used in conjunction with the preferred embodiments; see generally Coldren et. al., “Introduction to VCSELs,” from Vertical Cavity Surface Emitting Lasers: Design, Fabrication, Characterization, and Applications, Wilmsen et. al., eds., Cambridge University Press (1999), at Chapter 1, which is incorporated by reference herein. It is to be further appreciated that while a bottom-emitting VCSEL structure having its n-type electrical contacts near the emitting surface is described, conversely-positioned electrical contact and/or top-emitting structures may be used. It is to be further appreciated that while the examples described herein comprise surface electrodes, an intra-cavity electrode architecture may also be used with the preferred embodiments.

VCSEL 302 has a planar wafer structure formed on a substrate 312, which in this particular embodiment is InP. VCSEL 302 further comprises an amorphous dielectric lower DBR 308 buried in a groove formed in substrate 312 and an InP lateral overgrowth (LOG) spacer layer 314 formed thereon. A vertical cavity 303 is defined by the lower DBR 308 and an upper amorphous dielectric DBR 306, as shown in FIG. 3. An active region 305 comprising a lower n-type cladding layer 316, a quantum well layer 304, and an upper p-type cladding layer 320 is formed on top of the spacer layer 314. Quantum well layer 304 is preferably a strained quantum well layer, as the lower transparency and higher differential gain achievable with strained quantum wells is necessary to produce above-room-temperature operating long-wavelength VCSELs. Group III-V semiconductor materials emitting in a long wavelength range (e.g., 1300 nm-1550 nm) may be used, such as InGaAsP or AlInGaAs material systems. A proton- or oxygen-implanted current confinement structure 318 is formed in the upper cladding layer 320 for current confinement. Upper DBR 306 is formed on the upper cladding layer 320, and a top electrical contact 322 is formed as shown in FIG. 3 to establish electrical connectivity to the upper cladding layer 320. A bottom electrical contact 310 is formed on the bottom side of substrate 312 in a manner that forms an aperture 324, the aperture further comprising an antireflective coating.

Typically, any suitable epitaxial deposition method, such as molecular beam epitaxy (MBE), metal organic chemical vapor deposition (MOCVD), or the like is used to make all the required multiple layers if epitaxial DBR materials such as AlAs/GaAs or InGaAs/InP are used. However, to accommodate amorphous dielectric DBR materials while still maintaining a single-growth process, amorphous deposition techniques are used to deposit the lower dielectric DBR, and then a lateral overgrowth technique is used to grow an InP spacer layer over the dielectric DBR layers. In accordance with a preferred embodiment, the InP lateral overgrowth layer formed using MOCVD advantageously serves the dual purposes of (1) providing a high-quality, low-dislocation, low-loss epitaxially-grown spacer material to achieve a long cavity length, and (2) accommodating the presence of the highly efficient dielectric DBR mirrors, which would otherwise bring about the need for a dual-growth fabrication process.

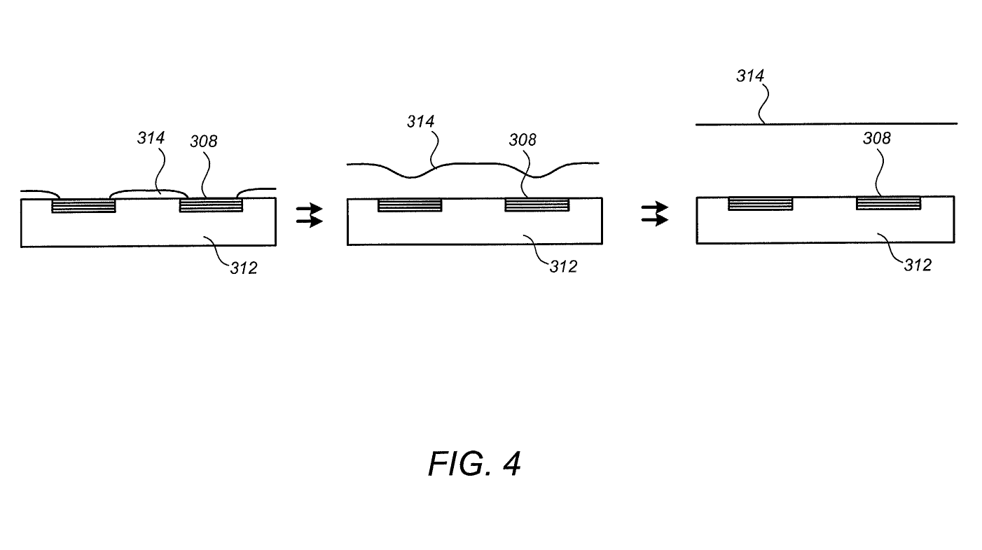

FIG. 4 conceptually illustrates the process of laterally overgrowing the spacer layer 314 on top of the lower DBR 308 and substrate 312, for two adjacent VCSELs on a common wafer. As discussed in Babic et. al., “Long-Wavelength Vertical-Cavity Lasers,” from Vertical Cavity Surface Emitting Lasers: Design, Fabrication, Characterization, and Applications, Wilmsen et. al., eds., Cambridge University Press (1999), at Chapter 8, which is incorporated by reference herein, an amorphous dielectric DBR structure such as an Si/SiO₂ structure is highly efficient as compared to AlAs/GaAs or InGaAs/InP structures, reaching a 99% reflectivity even when only a few quarter-wave layers (e.g., 4-6 layers) are present. Although the lower DBR 308 is relatively thin, perhaps one to two wavelengths thick, it is preferable to bury it in the InP substrate 312 prior to instantiation of the lateral overgrowth process, such that the top surface of the lower DBR 308 is even with, or slightly below, the surface of the InP substrate 312. This allows for the top of the lateral overgrowth layer to become very flat very quickly, as shown in FIG. 3. Advantageously, because the InP lying above the DBR 308 it is laterally overgrown, there are fewer dislocations in this area as compared to InP that is not laterally overgrown.

According to a preferred embodiment, the spacer layer 314 is grown to a sufficient thickness such that, when the active region 305 is subsequently formed using known methods, the overall length of the vertical cavity 303 will be the desired thickness. In one preferred embodiment, the spacer layer occupies at least 50 percent of the height of the vertical cavity 303. The effective length L_{eff} of the vertical cavity 303 is can range from a few wavelengths, up to 10 wavelengths, and even up to 50 wavelengths or greater in accordance with the preferred embodiments, as described supra. It has been found that when very thick spacer layers are required, sufficient flatness of the lateral overgrowth spacer layer 314 is achieved even if the lower DBR 308 is not buried in the substrate 312. Thus, in alternative preferred embodiment, the lower DBR 308 is not buried in the substrate 312 and is simply deposited on top of it.

According to a preferred embodiment, the VCSEL 302 can be made multi-longitudinal mode through proper selection of the active region materials, which is a primary influence on the location and shape of the gain spectrum curve, and proper selection of the effective vertical cavity length L_{eff}, which is a primary influence on the location and spacing of the candidate longitudinal mode wavelengths. Single-transverse-mode operation is achieved by narrowing the aperture (for example, by narrowing the current confinement aperture or other intra-cavity aperture (not shown)) with respect to the cavity length as known in the art, with one suitable range of aperture widths lying between about 4 μm-12 μm. Advantageously, however, single-transverse-mode power is enhanced by the combination of the longer cavity length and the multiple longitudinal modes in accordance with the preferred embodiments.

Although the DBR mirrors 306 and 308 are dielectric in the example of FIG. 3, they may alternatively comprise different amorphous materials, such as certain conducting or partially conducting amorphous materials that provide sufficient DBR efficiency (e.g., TiO₂/SiO₂, SiC/Si). While the features and advantages of the preferred embodiments are of particular strategic use when the DBR material cannot be epitaxially grown on a substrate, as in the case of amorphous materials, the scope of the preferred embodiments is not necessarily limited to such materials.

An additional advantage of a longer cavity length for vertical cavity 303 relates to heat dissipation. Because the cavity is longer, the VCSEL 302 is generally of a greater overall size and mass than shorter-cavity VCSELS. The increased mass contributes to higher overall heat capacity of the VCSEL 302 thereby enhancing heat dissipation.

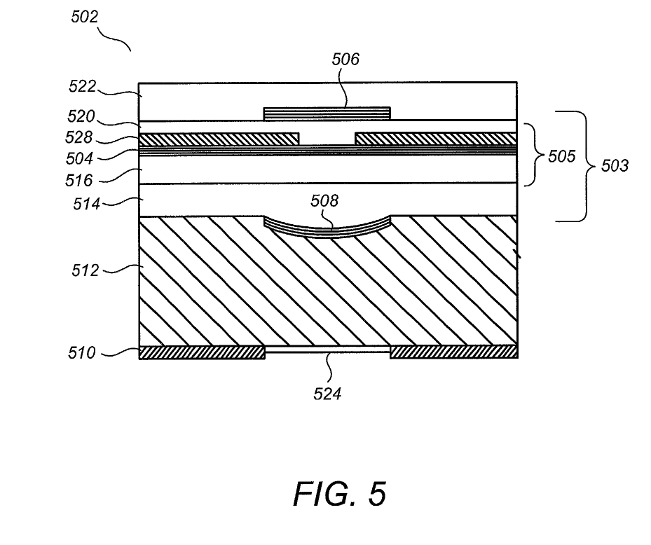

FIG. 5 illustrates a VCSEL 502 having a concave distributed Bragg reflector (DBR) mirror 508 in accordance with a preferred embodiment. VCSEL 502 comprises elements 503-506 and 510-524 similar to elements 303-306 and 310-324 of FIG. 3, except that the bottom DBR 508 is concave in shape. As used herein, the concavity or convexity of a surface is identified with respect to the inside of the vertical cavity. Generally speaking, although an example is given herein in which the lower DBR adjacent the VCSEL substrate is curved, it is to be appreciated that one or both DBR mirrors may be curved in accordance with the preferred embodiments.

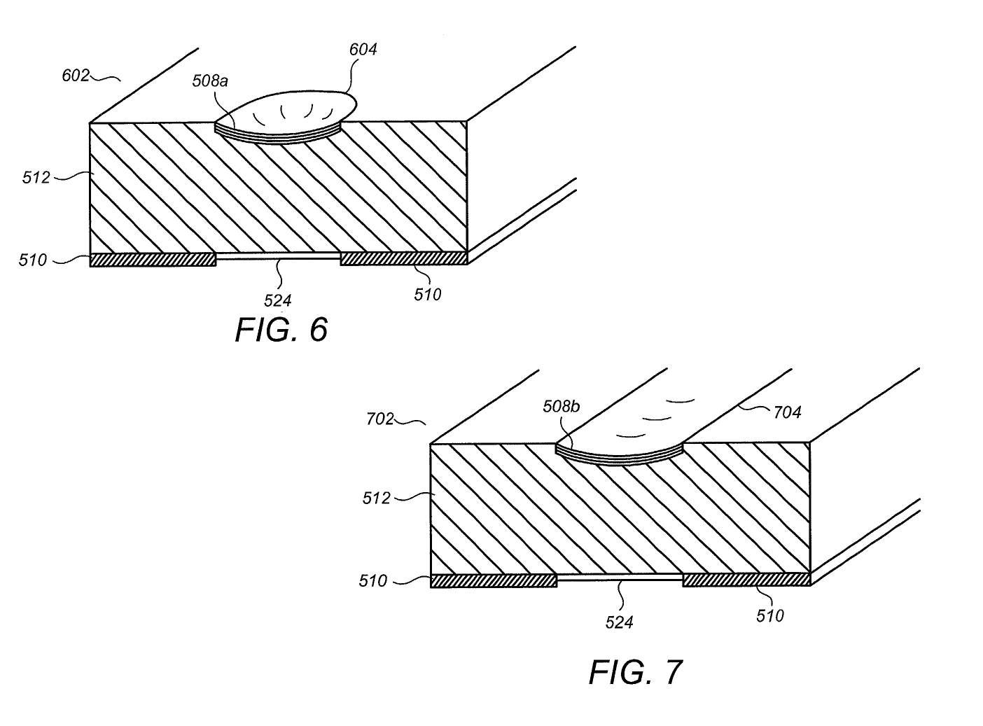

FIGS. 6 and 7 show two VCSELs 602 and 702 in accordance with the preferred embodiments. As indicated in these figures, in one preferred embodiment the curved DBR 508 may be curved in two lateral directions to form a spherical or parabolic cap 604. While the shape of the DBR 508 would look circular when viewed from above in the example of FIG. 6, in alternative preferred embodiments the shape may be square, hexagonal, octagonal, triangular, or other polygonal shapes. In another preferred embodiment, the curved DBR 508 may be curved in a single lateral direction to form a one-dimensional cylindrical or parabolic reflector 704.

Referring back to FIG. 5, an optical cavity or optical resonator is formed between the upper DBR 506 and the lower DBR 508. As known in the art (see, e.g., Yariv, Introduction to Optical Electronics, Holt Rinehart & Winston (1976) at pp. 70 et. seq.), optical cavities can be classified as stable, unstable, or critical. Most prior art VCSELs have an optical cavity consisting of two parallel planar reflectors, referred to as a plane-parallel resonator. According to known cavity theory, the plane-parallel resonator is a critical resonator lying between the stable and unstable regions. The stability condition for an optical resonator comprising two opposing spherical reflectors can be expressed as shown in Eq. (3) below, where R₁ and R₂ are the radii of curvature of the respective mirrors and L is the cavity length:

$$0 < ( 1 - \frac{L}{{R}_{1}} ) ( 1 - \frac{L}{{R}_{2}} ) < 1 \qquad \{ 3 \}$$

Letting R₁ represent the radius of curvature of the lower DBR 508 and R₂ be infinite to represent the planar upper DBR 506, a stable resonator will result where R₁ is greater than the cavity length L. For feasibility of manufacturing, R₁ will usually be many times greater than the cavity length L. In one preferred embodiment R₁ is approximately 10 times the cavity length L, while in another preferred embodiment R₁ may be 50 times the cavity length L. The scope of the preferred embodiments is not limited to the cylindrical/spherical case of Eq. (3), and the curved DBR may be any of a variety of concave or cap-like shapes. Generally speaking, curving the lower DBR according to the preferred embodiments supra reduces cavity losses such as optical diffraction loss, geometrical loss, and the like. Advantageously, the reduced cavity losses are associated with reduced threshold current for the VCSEL 502. This is particularly useful for incorporation into longer-cavity VCSELs that may otherwise have an increased lasing threshold current due to their longer vertical cavity length. Additionally, in the case of a single-mode VCSEL, single-mode performance is enhanced and far-field angle is decreased. While the curved DBR structure of FIG. 5 is advantageously used in conjunction with the long cavity, single-transverse-mode, multiple-longitudinal-mode VCSEL of the preferred embodiments supra, it is to be appreciated that the features advantages of a curved DBR structure can be used in conjunction with many different types of VCSEL structures for a variety of different applications.

Except for the special concave surface to be formed in the substrate 512, the VCSEL 502 may be fabricated according to methods described supra or other known methods. Advantageously, the use of a lateral overgrowth spacer layer 514 allows for a high-quality, low loss spacer region that conforms to both the curved DBR surface and the flat upper layers. In one preferred embodiment, the concave surface can be directly formed in the substrate by chemical etching in a manner similar to that discussed in Adachi et. al., “Chemical Etching Characteristics of (001) InP,” J. Electrochemical Society, Vol. 128, pp. 1342-49 (1981), which is incorporated by reference herein, using the proper choices of etchant and groove opening direction, as well as proper control of the width of the groove opening and/or etching time.

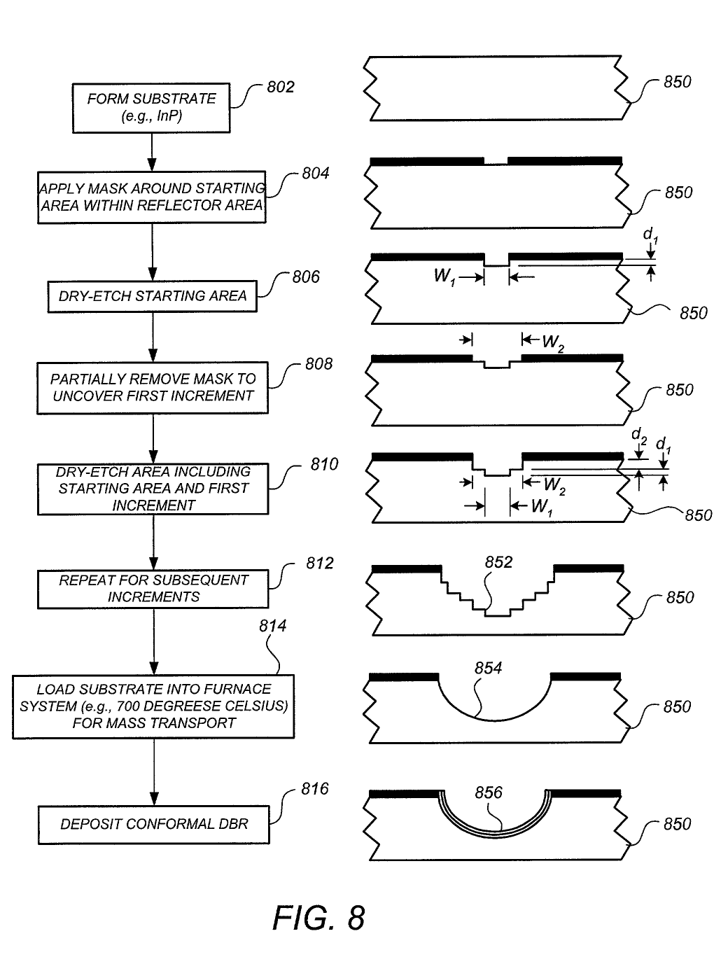

FIG. 8 illustrates steps for forming a concave DBR well in accordance with a preferred embodiment. Generally speaking, a special photolithographic process can be used for making a concave surface in the substrate by using multiple dry etching and mass transportation technology. While a one-dimensional example is presented here that forms a one-dimensional concave groove, it is readily extended to two dimensions for forming a spherical or parabolic cap. At step 802, a substrate 850 (e.g., InP) is formed, e.g., using a pulling method. At step 804, a mask is applied around a starting area of width W₁ near the center of the area that will become the DBR. At step 806, the starting area is dry etched to form a groove of width W₁ and a depth d₁. At step 808, the mask is partially removed to uncover a first increment around a starting area having a width W₂>W₁. At step 810, the wafer is again dry etched, causing the first incremental area to be etched to a depth d₂, and causing the starting area to be further etched to a depth (d₂+d₁). The process is repeated for one or more subsequent increments, with the widths Wₙ and incremental depths dₙ being adjusted appropriately to achieve a rough version 852 of the desired concave shape (step 812). At step 814, the substrate is loaded into a furnace system at a very high temperature such as 700 degrees Celsius for mass transport. The effect of the mass transportation process will be to smooth out the rough edges and for the desired concave shape 854. See generally Liau, “Surface Emitting Laser With Low Threshold Current And High-Efficiency,” Applied Physics Letters, vol. 46, pp. 115-117 (1985), which is incorporated by reference herein. At step 816, a DBR 856 is conformally deposited in the concave shape 854.

In an alternative preferred embodiment, a layer of InP may be epitaxially grown upon the substrate 512, and the concave shape and lower DBR 508 may be formed in the epitaxial InP layer. In another alternative preferred embodiment in which a long laterally overgrown spacer 514 is used, the lower DBR 508 may be constructed upon a concave mesa-like InP structure built above the substrate 512. Prior to deposition of the dielectric DBR thereon, the concave mesa-like InP structure will stand above the remainder of the substrate 512 in a manner similar to the way in which a sports stadium stands above the surrounding parking lot. Generally speaking, the method of constructing the mesa-like structure will involve a series of masking and growing steps conversely related to the embodiment of FIG. 8 supra. This preferred embodiment is possible when the laterally overgrown spacer layer 514 is very long, because there will be sufficient vertical space to achieve sufficient flatness of this layer prior to formation of the active region 505.

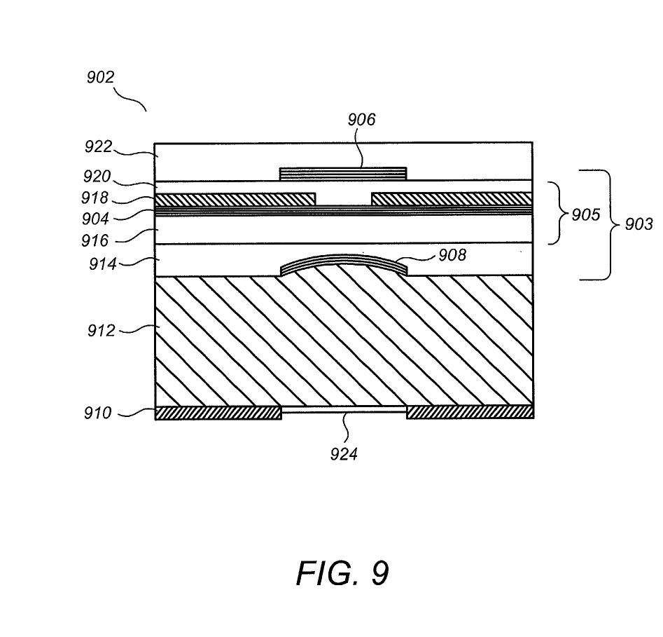

FIG. 9 illustrates a VCSEL 902 having a convex distributed Bragg reflector (DBR) mirror 908 in accordance with a preferred embodiment. VCSEL 902 comprises elements 903-906 and 910-924 similar to elements 303-306 and 310-324 of FIG. 3, except that the bottom DBR 908 is convex in shape. If we use a convex reflector not satisfying the stability condition (R₁<0) to replace one of the plane reflectors in a conventional VCSEL structure, the resonant cavity becomes unstable. Accordingly, the cavity will have high cavity loss for certain higher-order transverse modes. For example, whereas a parallel-DBR VCSEL may have a certain higher-order mode that resonates along a path that is at an angle “γ” compared to the fundamental mode, the VCSEL 902 may have a corresponding higher-order mode that resonates along a path that is at an angle “aγ” compared to the fundamental mode, where a>1. In turn, because the higher-order modes are at a greater angle with respect to the fundamental mode, the aperture size may be increased while retaining single-transverse mode operation. The bias current of the VCSEL 902 may be higher than the bias current of a corresponding parallel-DBR VCSEL. In addition to other uses for single-transverse-mode VCSELs, the VCSEL 902 may be particularly suitable for very high-speed operation.

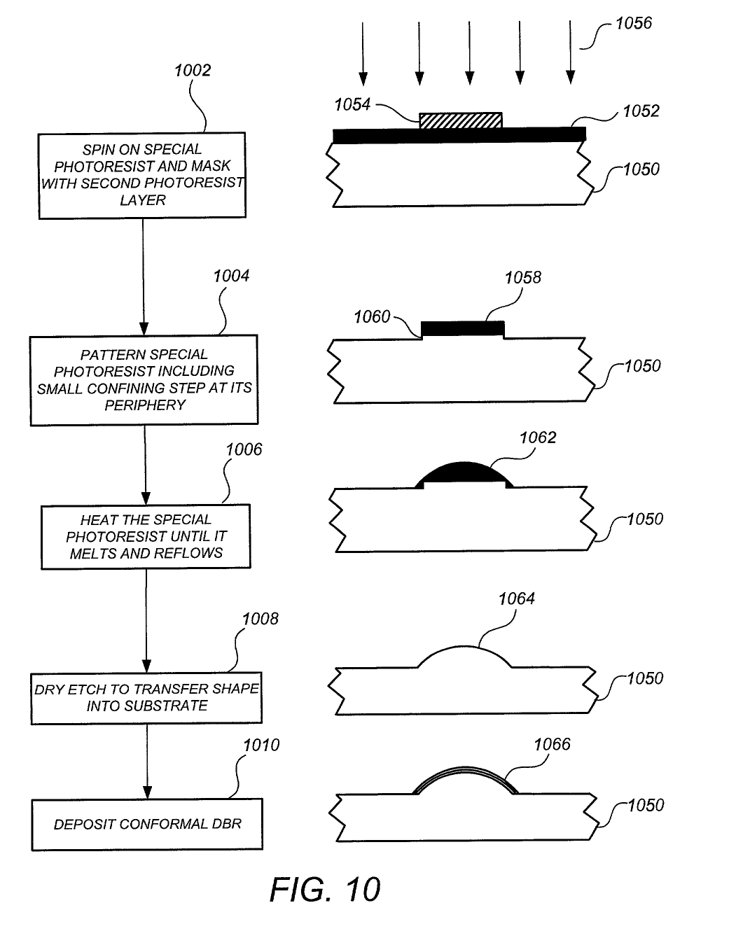

FIG. 10 shows steps for generating a convex surface on a substrate 1050 in preparation for deposition of a convex DBR in accordance with a preferred embodiment. In many ways, these steps are analogous to steps for forming convex lenses on VCSEL surfaces as discussed in Coldren, supra. At step 1002, a special photoresist 1052 such as PMGI (a deep UV resist) is spun on the substrate 1050 and then masked with a second photoresist layer 1054. The structure is exposed to ultraviolet light rays 1056 and then patterned such that a section 1058 of the special photoresist remains and a small confining step 1060 is formed around the periphery of the section (step 1004). At step 1006, the structure is heated until the special photoresist melts and reflows into a convex shape 1062. At step 1008, the wafer is dry etched to transfer the convex shape into the substrate 1050 to form a convex structure 1064. At step 1010, a DBR 1066 is conformally deposited on the convex structure 1062. Subsequent to the steps shown in FIG. 10, the spacer layer 914 is laterally overgrown, and the upper layers of the VCSEL 902 are formed using steps described supra.

Whereas many alterations and modifications of the present invention will no doubt become apparent to a person of ordinary skill in the art after having read the foregoing description, it is to be understood that the particular embodiments shown and described by way of illustration are in no way intended to be considered limiting. By way of example, it is to be appreciated that a person skilled in the art would be readily able to adapt the methods and structures of the preferred embodiments to both top and bottom-emitting VCSELs. By way of further example, it is to be appreciated that a person skilled in the art would be readily able to adapt the methods and structures of the preferred embodiments to VCSELs having a top semiconductor DBR, to VCSELs having any of a variety of different current confinement mechanisms (e.g., hole defined oxidation, “buried” mesa), to VCSELs having a variety of different wavelengths and active region materials and structures, and generally to many different kinds of VCSELs.

What is claimed is:

1. A data communications link, comprising:
an optical source comprising a single transverse mode, multiple longitudinal mode laser device;
an optical receiver separated from said optical source by less than 10 km; and
a single mode optical fiber for transmitting an optical signal generated by said optical source to said optical receiver;
the presence of multiple longitudinal modes facilitating increased single transverse mode output power and thermal stability in the optical source, and said data communications link achieving a data throughput performance substantially higher than 1 Gbps-km.

2. The data communications link of claim 1, wherein said optical signal generated by said optical source comprises a first longitudinal mode at a wavelength greater than 1200 nm.

3. The data communications link of claim 2, wherein said optical signal generated by said optical source further comprises a second longitudinal mode having a power that is greater than −20 dB with respect to a power of said first longitudinal mode.

4. The data communications link of claim 2, wherein said optical signal generated by said optical source further comprises a third longitudinal mode having a power that is greater than −20 dB with respect to a power of said first longitudinal mode.

5. The data communications link of claim 2, wherein said first longitudinal mode lie s between 1200 nm and 1570 nm, and wherein said optical receiver is sufficiently close to said optical source such that attenuation and chromatic dispersion of the optical signal between said optical source and said optical receiver are nonlimiting factors in designing the data communications link.

6. The data communications link of claim 5, wherein said optical receiver is separated from said optical source by less than 1 km, whereby attenuation and chromatic dispersion of the optical signal between said optical source and said optical receiver are negligible factors in designing the data communications link.

7. The data communications link of claim 1, said laser device comprising an active region having a gain spectrum, said laser device further comprising an optical cavity defining a plurality of possible longitudinal modes separated by a longitudinal mode spacing, wherein said gain spectrum has a width greater than two times said longitudinal mode spacing.

8. The data communications link of claim 7, wherein said gain spectrum has a width greater than five times said longitudinal mode spacing.

9. The data communications link of claim 7, further comprising:
at least one additional optical source also comprising a single transverse mode, multiple longitudinal mode laser device, wherein said optical sources generate a plurality of optical signals at different wavelengths;
a wavelength division multiplexing (WDM) multiplexer positioned between said optical sources and said single mode optical fiber for generating a wavelength division multiplexed (WDM) optical signal from said plurality of optical signals;
a WDM demultiplexer positioned to receive and separate said WDM optical signal into said plurality of optical signals; and
at least one additional optical receiver corresponding to said at least one additional optical source.

10. The data communications link of claim 9, wherein said WDM optical signal comprises at least four channels at wavelengths greater than 1200 nm, said channels being spaced apart by at least 20 nm.

11. The data communications link of claim 10, wherein at least one of said optical channels lies in a wavelength range corresponding to an OH absorption peak of the single mode optical fiber.

12. The data communications link of claim 2, wherein said laser device comprises a vertical cavity surface emitting laser (VCSEL), said VCSEL having an effective cavity length that is at least three times said wavelength of said first longitudinal mode.

13. The data communications link of claim 12, wherein said effective cavity length is at least ten times said wavelength of said first longitudinal mode.

14. The data communications link of claim 12, wherein said effective cavity length is at least fifty times said wavelength of said first longitudinal mode.

15. The data communications link of claim 12, said VCSEL comprising a first distributed Bragg reflector (DBR), a second DBR, and a vertical cavity therebetween, wherein said first DBR comprises an amorphous material.

16. The data communications link of claim 15, wherein said amorphous material is a dielectric material.

17. The data communications link of claim 15, said VCSEL further comprising a lateral overgrowth layer between said first and second DBRs.

18. The data communications link of claim 17, wherein said lateral overgrowth layer has a length that is at least fifty percent of said effective cavity length.

19. The data communications link of claim 18, said VCSEL comprising a substrate upon which said first DBR is deposited in a manner that exposes a portion of said substrate after said deposition, said lateral overgrowth layer being formed by epitaxially growing an overgrowth material over said substrate such that said overgrowth material converges over said first DBR and achieves sufficient flatness for epitaxial growth of subsequent vertical cavity layers thereon.

20. The data communications link of claim 19, wherein said substrate comprises InP, and wherein said lateral overgrowth material comprises InP.

21. The data communications link of claim 19, said subsequent vertical cavity layers including active region layers, wherein said VCSEL is fabricated according to a single-growth process not requiring a wafer bonding step.

22. The data communications link of claim 19, wherein said first DBR is curved to form a concave shape with respect to the vertical cavity such that said vertical cavity forms a stable resonant cavity.

23. The data communications link of claim 19, wherein said first DBR is curved to form a convex shape with respect to the vertical cavity such that said vertical cavity forms an unstable resonant cavity.

24. An optical communications link, comprising:
a single transverse mode, multiple longitudinal mode optical source;
an optical receiver; and
a single mode optical fiber for transmitting an optical signal generated by said optical source to said optical receiver;
said optical receiver being sufficiently close to said optical source to effectively make attenuation and chromatic dispersion of the optical signal between said optical source and said optical receiver nonlimiting factors in designing the optical communications link.

25. The optical communications link of claim 24, wherein said optical receiver is less than 10 km from said optical source.

26. The optical communications link of claim 25, wherein said optical signal generated by said optical source comprises a dominant longitudinal mode and at least one side longitudinal mode, and wherein said at least one side longitudinal mode has a power level that is greater than −20 dB with respect to a power level of the dominant longitudinal mode.

27. The optical communications link of claim 26, wherein said dominant longitudinal mode is at a wavelength greater than 1200 nm.

28. The optical communications link of claim 24, wherein said optical source comprises a vertical cavity surface emitting laser (VCSEL), said VCSEL having an effective cavity length that is at least three times said wavelength of said dominant longitudinal mode.

29. The optical communications link of claim 28, wherein said effective cavity length is at least ten times said wavelength of said dominant longitudinal mode, whereby said longitudinal modes are spaced apart by less than 30 nm.

30. The optical communications link of claim 29, wherein at least fifty percent of said effective cavity length is occupied by a spacer layer formed by lateral overgrowth of an epitaxial material over an amorphous material.

31. The optical communications link of claim 30, said VCSEL comprising a distributed Bragg reflector (DBR) defining one end of a vertical cavity thereof, wherein said DBR comprises said amorphous material.

32. The optical communications link of claim 31, said VCSEL comprising a substrate upon which said DBR is deposited and from which said spacer layer is laterally overgrown over said DBR.

33. The optical communications link of claim 32, wherein said substrate comprises InP, and wherein said DBR comprises a dielectric material.

34. The optical communications link of claim 32, wherein said DBR is at least partially buried in said substrate prior to said lateral overgrowth of said spacer layer to facilitate flatness of a top surface of said spacer layer prior to epitaxial growth of subsequent material layers thereon.

35. The optical communications link of claim 32, wherein said DBR is curved to form a concave shape with respect to said vertical cavity such that said vertical cavity forms a stable resonant cavity.

36. The optical communications link of claim 32, wherein said DBR is curved to form a convex shape with respect to said vertical cavity such that said vertical cavity forms an unstable resonant cavity.

37. An apparatus for facilitating data communications between a source location and a receiver location, comprising:
a vertical cavity surface emitting laser (VCSEL) at the source location, said VCSEL being designed to operate in a single transverse mode, multiple longitudinal mode manner; and
a single mode optical fiber for transmitting an optical signal generated by said VCSEL to said receiver location.

38. The apparatus of claim 37, said VCSEL comprising a vertical cavity having an effective cavity length and an active region having a gain spectrum, wherein said effective cavity length is sufficient to cause at least two possible longitudinal modes to fall within said gain spectrum.

39. The apparatus of claim 38, wherein said effective cavity length is greater than five times an operating wavelength of said VCSEL.

40. The apparatus of claim 39, wherein said VCSEL comprises a laterally overgrown spacer layer occupying at least fifty percent of said effective cavity length.

41. An apparatus for facilitating data communications between a source location and a receiver location separated by a distance for which a single-mode fiber causes less than 15 dB of attenuation and less than 200 ps/nm of chromatic dispersion, comprising:
a vertical cavity surface emitting laser (VCSEL) at the source location, said VCSEL being designed to operate in a single transverse mode; and
a single mode optical fiber for transmitting an optical signal generated by said VCSEL to said receiver location.

42. The apparatus of claim 41, said VCSEL comprising a vertical cavity having an effective cavity length and an active region having a gain spectrum, wherein said effective cavity length is sufficient to cause at least two possible longitudinal modes to fall within said gain spectrum, and wherein said VCSEL emits at least two longitudinal modes comprising a dominant longitudinal mode and a side longitudinal mode, said side longitudinal mode being at least −20 dB with respect to said dominant longitudinal mode.

43. The apparatus of claim 42, wherein said effective cavity length is greater than five times a wavelength of said dominant longitudinal mode.

44. The apparatus of claim 43, wherein said VCSEL comprises a laterally overgrown spacer layer occupying at least fifty percent of said effective cavity length.

45. An apparatus for facilitating data communications between a source location and a receiver location, comprising:
a plurality of vertical cavity surface emitting lasers (VCSELs) at the source location, each VCSEL emitting an optical signal corresponding to a different source channel, each VCSEL being designed to operate in a single transverse mode, multiple longitudinal mode manner;
a wavelength division multiplexing (WDM) device for combining said plurality of optical signals into a single wavelength division multiplexed (WDM) signal; and
a single mode optical fiber for transmitting said WDM signal to said receiver location.

46. The apparatus of claim 45, each of said plurality of VCSELs comprising a vertical cavity having an effective cavity length and an active region having a gain spectrum, wherein said effective cavity length is sufficient to cause at least two possible longitudinal modes to fall within said gain spectrum, and wherein said VCSEL emits at least two longitudinal modes including a dominant longitudinal mode and a side longitudinal mode, said side longitudinal mode being at least −20 dB with respect to said dominant longitudinal mode.

47. The apparatus of claim 46, wherein said effective cavity length is greater than five times a wavelength of said dominant longitudinal mode.

48. The apparatus of claim 47, wherein said VCSEL comprises a laterally overgrown spacer layer occupying at least fifty percent of said effective cavity length.

49. The apparatus of claim 46, wherein said effective cavity length for each of said plurality of VCSELs is greater than ten times a wavelength of said dominant longitudinal mode for that VCSEL, wherein said side longitudinal mode for each of said plurality of VCSELs is within 30 nm of said dominant longitudinal mode for that VCSEL, and wherein said WDM signal comprises at least two channels at wavelengths greater than 1200 nm that are spaced apart by at least 60 nm.

50. The apparatus of claim 49, wherein said WDM signal comprises at least four channels at wavelengths greater than 1200 nm that are spaced apart by at least 60 nm.

51. A vertical cavity surface emitting laser (VCSEL), comprising a first distributed Bragg reflector (DBR) and a second DBR defining a vertical cavity therebetween having an effective vertical cavity length, wherein said effective vertical cavity length is at least ten times an operating wavelength of the VCSEL.

52. The VCSEL of claim 51, wherein said effective vertical cavity length is at least fifty times said operating wavelength of the VCSEL.

53. The VCSEL of claim 51, wherein said first DBR is curved such that said vertical cavity forms a stable resonant cavity.

54. The VCSEL of claim 51, wherein said first DBR is curved such that said vertical cavity forms an unstable resonant cavity.

55. The VCSEL of claim 51, wherein said first DBR comprises an amorphous material, the VCSEL further comprising:
a first layer upon which said first DBR is formed, said first layer comprising a material capable of accommodating epitaxial growth;
a second layer epitaxially grown from said first layer in a manner that laterally covers said first DBR; and
a third layer epitaxially grown upon said second layer.

56. The VCSEL of claim 55, wherein said first DBR is at least partially buried in a trench formed in said first layer.

57. The VCSEL of claim 56, said trench being concave in shape with respect to the vertical cavity, said DBR being conformally deposited thereon, wherein said vertical cavity forms a stable resonant cavity.

58. The VCSEL of claim 57, said operating wavelength being greater than 1200 nm, wherein said first and second layers comprise InP.

59. The VCSEL of claim 58, wherein said amorphous material is a dielectric material.

60. The VCSEL of claim 55, wherein said second layer occupies at least fifty percent of the effective cavity length of said vertical cavity.

61. A vertical cavity surface emitting laser (VCSEL), comprising a first distributed Bragg reflector (DBR) and a second DBR defining a vertical cavity therebetween, wherein said first DBR is curved such that said vertical cavity forms a stable resonant cavity.

62. The VCSEL of claim 61, further comprising:
a first layer upon which said first DBR is formed, said DBR comprising an amorphous material, said first layer comprising an epitaxial material; and
a lateral overgrowth layer that is epitaxially grown from said first layer over said first DBR.

63. The VCSEL of claim 62, further comprising an active region having a gain spectrum lying above 1200 nm, wherein an effective length of said vertical cavity is sufficiently long such that at least two longitudinal modes fall within said gain spectrum, and wherein said VCSEL emits a dominant longitudinal mode and a side longitudinal mode having a power level not less than −20 dB of a power level of the dominant longitudinal mode.

64. The VCSEL of claim 63, wherein said VCSEL is configured and dimensioned to operate in a single transverse mode, and wherein said lateral overgrowth layer occupies at least fifty percent of the effective length of said vertical cavity.

65. The VCSEL of claim 64, wherein said first DBR comprises a dielectric material.

66. A vertical cavity surface emitting laser (VCSEL), comprising a first distributed Bragg reflector (DBR) and a second DBR defining a vertical cavity therebetween, wherein said first DBR is curved such that said vertical cavity forms an unstable resonant cavity.

67. The VCSEL of claim 66, further comprising:
a first layer upon which said first DBR is formed, said DBR comprising an amorphous material, said first layer comprising an epitaxial material; and
a lateral overgrowth layer that is epitaxially grown from said first layer over said first DBR.

68. The VCSEL of claim 67, further comprising an active region having a gain spectrum lying above 1200 nm, wherein an effective length of said vertical cavity is sufficient such that at least two longitudinal modes fall within said gain spectrum, and wherein said VCSEL emits a dominant longitudinal mode and a side longitudinal mode having a power level not less than −20 dB of a power level of the dominant longitudinal mode.

69. The VCSEL of claim 68, wherein said VCSEL is configured and dimensioned to operate in a single transverse mode, and wherein said lateral overgrowth layer occupies at least fifty percent of the effective length of said vertical cavity.

70. The VCSEL of claim 69, wherein said first DBR comprises a dielectric material.

71. A single transverse mode, multiple longitudinal mode VCSEL configured to operate at a wavelength above 1200 nm, comprising:
a first distributed Bragg reflector (DBR) and a second DBR defining a vertical cavity therebetween having an effective cavity length;
a spacer layer lying within said vertical cavity, said spacer layer occupying more than fifty percent of the effective cavity length; and
an active region lying in said vertical cavity, said active region having a gain spectrum lying above 1200 nm;
wherein said spacer layer is sufficiently thick for said vertical cavity to accommodate at least two longitudinal modes within said gain spectrum.

72. The single transverse mode, multiple longitudinal mode VCSEL of claim 71, wherein said active region comprises layers consistent with a InGaAsP or AlInGaAs material system.

73. The single transverse mode, multiple longitudinal mode VCSEL of claim 71, wherein said gain spectrum has an effective width of at least 60 nm, and wherein said effective cavity length is greater than ten times the operating wavelength.

74. The single transverse mode, multiple longitudinal mode VCSEL of claim 73, wherein a dominant longitudinal mode and at least one side longitudinal mode are emitted by said VCSEL, said side longitudinal modes having a power that is at least −20 dB of the power of said dominant longitudinal mode.

75. The single transverse mode, multiple longitudinal mode VCSEL of claim 71, wherein said first DBR comprises an amorphous material, and wherein said spacer layer is laterally overgrown on said first DBR.

76. The single transverse mode, multiple longitudinal mode VCSEL of claim 75, further comprising an InP substrate, wherein said first DBR is deposited on said InP substrate, and wherein said spacer layer comprises InP.

77. The single transverse mode, multiple longitudinal mode VCSEL of claim 75, wherein said first DBR comprises a dielectric material.

78. The single transverse mode, multiple longitudinal mode VCSEL of claim 71, wherein said first DBR is curved such that said vertical cavity forms a stable resonant cavity.

79. The single transverse mode, multiple longitudinal mode VCSEL of claim 71, wherein said first DBR is curved such that said vertical cavity forms an unstable resonant cavity.

80. A method for fabricating a vertical cavity surface emitting laser (VCSEL) having a concave reflective surface therein, comprising the steps of:
forming a concave well in a substrate;
forming a first reflective element conformal to said concave well;
forming a spacer layer immediately above said first reflective element, said spacer layer being optically inactive with respect to an electric current therethrough;
forming active region layers above said spacer layer, said active region being optically responsive to an electric current therethrough; and
forming a second reflective element above said vertical cavity layers.

81. The method of claim 80, wherein the forming of said first reflective element comprises forming a distributed Bragg reflector (DBR) comprising an amorphous material, wherein said forming a well comprises forming the well in a substrate comprising a first material accommodating epitaxial growth, and wherein said step of forming a spacer layer comprises of epitaxially and laterally overgrowing a second material from said substrate over said DBR until a top surface of the spacer layer is substantially flat.

82. The method of claim 81, wherein said first and second materials are InP, and wherein said DBR comprises a dielectric material.

83. The method of claim 80, said step of forming a concave well comprising the steps of:
sequentially etching patterns of different lateral sizes into said substrate until an intermediate well is formed having stair-like structures on its surface; and
heating the substrate at very high temperatures until a mass transportation effect causes the stair-like structures to substantially smooth out.

84. The method of claim 83, further comprising the step of conformally depositing the DBR in the concave well.

85. A method for fabricating a vertical cavity surface emitting laser (VCSEL) having a convex reflective surface therein, comprising the steps of:
forming a substrate having a convex structure thereon;
forming a first reflective element conformal to said convex structure;
forming a spacer layer immediately above said first reflective element, said spacer layer being optically inactive with respect to an electric current therethrough;
forming active region layers above said spacer layer, said active region being optically responsive to an electric current therethrough; and
forming a second reflective element above said vertical cavity layers.

86. The method of claim 85, wherein the forming of said first reflective element comprises forming a distributed Bragg reflector (DBR) comprising an amorphous material, wherein said forming a substrate comprises forming a substrate that includes a first material capable of accommodating epitaxial growth, and wherein said forming of a spacer layer comprises epitaxially and laterally overgrowing a second material from said substrate over said DBR until a top surface of the spacer layer is substantially flat.

87. The method of claim 86, wherein said first and second materials are InP, and wherein said DBR comprises a dielectric material.

88. The method of claim 86, said forming a substrate having a convex structure thereon comprising the steps of:
forming a photoresist layer over a lateral portion of the substrate corresponding to the convex structure;
heating the substrate until said photoresist layer melts and reflows into a convex shape corresponding to the convex structure;
dry etching the substrate including said lateral portion until the convex shape is transferred to the substrate.

89. The method of claim 88, further comprising the step of conformally depositing the DBR on the convex structure.

90. An apparatus, comprising:
a plurality of optical communication links, each optical communications link comprising:
a single transverse mode, multiple longitudinal mode optical source;
an optical receiver; and
a single mode optical fiber for transmitting an optical signal generated by said optical source to said optical receiver;
wherein said single mode optical fibers are contained in a common multifiber cable extending from a first location containing said optical sources to a second location containing said optical receivers; and
wherein said second location is sufficiently close to said first location to effectively make attenuation and chromatic dispersion of each of said optical signals nonlimiting factors in designing its respective optical communications link.

91. The apparatus of claim 90, wherein said multifiber cable comprises a fiber optic ribbon cable.

92. The apparatus of claim 90, wherein said second location is less than 10 km from said first location.

93. An apparatus, comprising:
a plurality of WDM optical communication links, each WDM optical communications link comprising:
a plurality of optical sources, each optical source generating a component optical signal;
a multiplexer for combining the component optical signals into a WDM optical signal;
an optical fiber for transporting said WDM optical signal;
a demultiplexer for receiving said WDM optical signal and separating it back into its component optical signals; and
a plurality of optical receivers for receiving said component optical signals;
wherein said optical fibers are contained in a common multifiber cable extending from a first location containing said optical sources to a second location containing said optical receivers; and
wherein said second location is sufficiently close to said first location to effectively make attenuation and chromatic dispersion of each of said WDM optical signals nonlimiting factors in designing its respective WDM optical communications link.

94. The apparatus of claim 93, wherein each of said optical sources comprises a single transverse mode, multiple longitudinal mode VCSEL, and wherein each of said optical fibers is a single mode fiber.

95. The apparatus of claim 93, wherein said multifiber cable comprises a fiber optic ribbon cable.

96. The apparatus of claim 93, wherein said second location is less than 10 km from said first location.
